(19) United States
(12) Patent Application Publication
(10) Pub. No.: US 2025/0032989 A1
(43) Pub. Date: Jan. 30, 2025

(54) ELECTROCHEMICALLY ASSISTED ION EXCHANGE WATER TREATMENT DEVICE HAVING SPECIFIC ARRANGEMENT OF ELECTROCHEMICAL CELLS

(71) Applicant: Zhejiang Qinyuan Water Treatment S. T. Co., Ltd., Ningbo City (CN)

(72) Inventors: Yao Wang, Shanghai (CN); Rui YAN, Shanghai (CN); Miaoquan HUANG, Ningbo (CN); Chengqian ZHANG, Ningbo (CN); Nan ZHAO, Ningbo (CN)

(73) Assignee: Zhejiang Qinyuan Water Treatment S. T. Co., Ltd., Ningbo City (CN)

(21) Appl. No.: 18/694,458

(22) PCT Filed: Sep. 21, 2022
(86) PCT No.: PCT/EP2022/076206

§ 371 Date: Mar. 22, 2024

(30) Foreign Application Priority Data
Sep. 24, 2021 (WO) PCT/CN2021/120488
Nov. 16, 2021 (EP) 21208358.8

(51) Int. Cl. B01D 61/44; B01D 61/46; B01D 63/12; B01D 69/02; B01D 69/12; C02F 1/28; C02F 1/469

(52) U.S. Cl. CPC B01D 61/445; B01D 61/46; B01D 63/12; B01D 69/02; B01D 69/12; C02F 1/283; C02F 1/4693; B01D 2311/06; B01D 2317/025; B01D 2317/04; B01D 2325/14; B01D 2325/16; B01D 2325/42; C02F 2301/08

(57) ABSTRACT

The invention relates to an electrochemically assisted ion exchange water treatment device comprising a first inlet feeding water into line L₀ a prefiltration unit, an electrochemical cell assembly capable of removing ions from a solution stream, the assembly comprising a first unit comprising at least two electrochemical cells connected in parallel with each other, and a second unit connected in series to the first unit; a second inlet for feeding water into line FL during regeneration state, wherein FL feeds water into the first and second units through lines FL12 and FL3 respectively; wherein line FL12 further branches into two lines to feed water into both cells of the first unit; a wastewater line WL and an outlet for discarding wastewater from the cells; a carbon filtration unit positioned downstream of the assembly; an outlet for dispensing treated water.

### FIELD OF THE INVENTION

The invention relates to an electrochemically assisted ion exchange water treatment device. More particularly, the invention relates to field of ion exchange, and to the use of ion exchange membranes in an electrochemical cell.

### BACKGROUND OF THE INVENTION

Ion exchange materials are used to remove or replace ions in solutions, for example in the production of high purity water by deionization, in wastewater treatment (the extraction of copper ions from industrial waste streams), and in selective substitution of ions in solution (e.g., water softening processes in which “hard” divalent ions, such as calcium, are replaced by “soft” sodium or potassium ions). Ion exchange materials are typically divided into two categories, namely cation exchange and anion exchange, both types generally being solids or gels which comprise replaceable ions, or which chemically react with specific ions to function as ion exchange materials. They may be cross-linked or not cross-linked organic polymers or inorganic structures such as zeolites. Cation exchange materials comprise acidic groups such as —COOM, —SO₃M, —PO₃M₂, and —C₆H₄OM, where M is a cation (e.g., hydrogen, sodium, calcium, or copper ion) that exchange cations with no permanent change to the structure of the material. Cation exchange materials are commonly subdivided into “strong acid” and “weak acid” types, terms which refer to the ion exchange group's acid strength or pKa. Strong acid types such as those comprising —SO₃M groups function over virtually the full range of solution acid strengths (e.g., pH=0 to 15). Weak acid types such as those comprising —COOM only serve as ion exchange materials when the pH is near or above the acid group's pKa. Cation exchange materials also include those comprising neutral groups or ligands that bind cations through coordinate rather than electrostatic or ionic bonds. For example, a pyridine group affixed to a polymer will form a coordinate bond to Cu⁺² ion to remove it from solution. Other cation exchange materials include polymers comprising complexing or chelating groups (e.g., those derived from aminophosphoric acid, aminocarboxylic acid, and hydroxamic acid).

Anion exchange materials exchange anions with no permanent change to the structure of the material, and comprise basic groups such as —NR₃A, NR₂HA, —PR₃A, —SR₂A, or C₅H₅NHA (pyridinium), where R is typically an aliphatic or aromatic hydrocarbon group and A is an anion (e.g., hydroxide, bicarbonate or sulfonate). Anion exchange materials are commonly subdivided into “strong base” and “weak base” types. Weak base resins such as —NR₂HA and C₅H₅NHA exchange anions only when the solution pH is near or below the basic group's pKa, while strong base resins such as —NR₃A function over a much wider range of solution pH values.

Ion exchange materials are useful in several forms, for example small or large spheres or beads, powders produced by pulverization of beads, and membranes. The simplest ion exchange membranes are monopolar membranes which comprise substantially only one of the two types of ion exchange materials: either cation or anion exchange materials. Another type of membrane is the water-splitting membrane, also known as bipolar, double, or laminar membranes. Water-splitting membranes are structures comprising a strong-acid cation exchange surface or layer (sulfonate groups; —SO₃M) and a strong-base anion exchange surface or layer (quaternary ammonium groups; —NR₃A) in combination such that in a sufficiently high electric field produced by application of voltage to two electrodes, water is irreversibly dissociated or “split” into its component ions H⁺ and OH⁻. The dissociation of water occurs most efficiently at the boundary between the cation and anion exchange layers in the water-splitting membrane, and the resultant H⁺ and OH⁻ ions migrate through the ion exchange layers in the direction of the electrode having an opposite polarity (e.g., H⁺ migrates toward the negative electrode).

Conventional ion exchange is a batch process typically employing ion exchange resin beads packed into columns. A single stream of solution to be treated (source solution) is passed through a column or channel. Ions in the solution are removed or replaced by the ion exchange material, and product solution or water emerges from the outlet of the column. When the ion exchange material is saturated with ions obtained from the source solution (e.g., its capacity is consumed or “exhausted”), the beads are regenerated with a suitable solution. Cation exchange resins are commonly regenerated using acidic solutions, and anion exchange resins are regenerated using basic solutions. During regeneration, the apparatus cannot be used for creating product solution or water. Regeneration is concluded with a rinsing step which removes entrapped regenerant solution. Such batch processes are contrasted with continuous processes that employ membranes which do not require a regeneration step.

Several important benefits accrue from batch ion exchange operation for solution treatment rather than a continuous process. First, ion exchange materials are highly selective, and exclusively remove or replace ions in solution, largely ignoring neutral groups. They may also be very selective in the removal or replacement of one type of ion over other ions. For example in water softening processes, cation exchange materials comprising sulfonate groups selectively extract multivalent ions such as calcium and magnesium from solution while leaving the monovalent ion concentration (e.g., sodium) unaffected. Water softening occurs because the sulfonate group has a ten-fold greater affinity (selectivity) for divalent ions than for monovalent ions. Alternatively, a chelating cation exchange group such as iminodiacetic acid is particularly suitable for selectively extracting copper ion from solutions containing other ions.

This ion exchange group has an eight order-of-magnitude greater affinity for copper ion than for sodium ion. A second advantage of batch ion exchange processes is their greater resistance to fouling from either biological growth (e.g., algae) or mineral scale. Strong acids and bases are most often used to regenerate cation and anion exchange materials, respectively, creating an environment in which biological organisms cannot survive. Mineral scale forms in neutral or basic environments (pH>7) in the presence of multi-valent cations; scale typically comprises calcium and magnesium carbonates, hydroxides and sulfates. Build-up of scale on surfaces or in channels of continuous apparatus for water treatment has a detrimental effect on ion removal efficiencies. Formation of scale in batch ion exchange systems is a less serious problem because of the frequent regeneration of cation exchange materials (where the multivalent cations are concentrated) with strong acids which rapidly dissolve scale. A third advantage is the potential to produce concentrated regenerant effluents (containing the ions removed in the preceding solution treatment step). This is important when the ion removed by the ion exchange material is the chemical of interest and one desires its isolation (for example an amino acid or protein removed from a cell culture). The ability to produce more concentrated regenerant effluents provides the further important benefits of consuming less water and placing a smaller burden on waste treatment plants.

Although batch type ion exchange processes have important benefits, the need for regenerant chemicals renders such processes expensive and environmentally unfriendly. The environmental costs associated with the purchase, storage, handling, and disposal of used toxic or corrosive regenerant chemicals such as sulfuric acid, hydrochloric acid, and caustic soda prohibit use of this ion exchange process in many applications. Even in water softening, while the sodium or potassium chloride regenerant is much less hazardous, the need for consumers to haul 22.67 kg (50 lb) bags of salt home from the grocery store to refill their softeners every several weeks is a major inconvenience. In addition, salt-rich regeneration effluent from water softeners which is washed into the sewer can be difficult to handle in municipal waste treatment facilities. Another negative environmental impact from chemical regeneration results from the need for large quantities of water to rinse the regenerated ion exchange column and prepare it for a subsequent operating step. Water is not only scarce in many regions of the world, but the resultant large volume of dilute waste rinse water must also be treated (e.g., neutralized) before disposal.

Continuous processes that avoid regenerant chemicals for the electrochemical regeneration of ion exchange materials are disclosed in for example U.S. Pat. No. 3,645,884 (Gilliland), U.S. Pat. No. 4,032,452 (Davis), and U.S. Pat. No. 4,465,573 (O'Hare). In these electrodialysis systems, the ion exchange material, most often in bead form, is separated from two electrodes by a multitude of monopolar cation and anion exchange membranes; the ion exchange bead material is then continuously regenerated by an electrodialysis process in which ions migrate in an electric field through the solution, beads, and compatible monopolar membranes (i.e., cations pass through monopolar cation exchange membranes, and anions pass through monopolar anion exchange membranes), until they are prevented from further movement by incompatible monopolar membrane barriers. This property of monopolar ion exchange membranes to pass ions of one polarity while preventing passage of ions of the opposite polarity is referred to as permselectivity. Because it is a continuous process, electrodialysis is characterized by two separate, contiguous solution streams of substantially different compositions, namely a product water stream from which ions are continuously removed, and a wastewater stream into which these ions are concentrated. A primary advantage of the electrodialysis process versus conventional ion exchange is its continuous operation which reduces down-time or avoids the need for a second (redundant) apparatus to operate during the regeneration of a first ion exchange column. A second important advantage is that the electrodialysis waste stream only contains the ions removed from the product water due to using electrical energy rather than chemical energy for removing or replacing ions. Because chemical regeneration in conventional ion exchange is a relatively slow and inefficient process, and it is important to minimize down-time, excess chemicals are typically employed. Thus, the regeneration solution in batch ion exchange processes contains a considerable excess of chemicals in addition to the ions which were removed from the product water in the preceding cycle. This is a significant complicating factor if one desires to recover the previously removed ions from the regenerant (e.g., copper ion). The excess chemicals also create a still further burden on waste treatment systems.

Continuous electrodialysis water treatment processes suffer from several drawbacks. First, it is a much less selective ion removal process that is governed by mass transport rates rather than by chemical equilibria. Since electrodialysis apparatus require the use of highly conductive membranes for good electrical efficiency and high mass transport rates, there is little latitude for optimizing membranes for the property of selectivity. A second drawback is that electrodialysis apparatus are prone to mineral scale fouling that interferes with flow of liquid, migration of ions, or effectiveness of the electrodes, causing eventually plugging up of the equipment. Thus, in many water deionization electrodialysis apparatus water must be softened prior to passing it through the device. Alternatively, when multivalent ions are introduced into the apparatus, the electrode polarity may be occasionally reversed as described in U.S. Pat. No. 2,863,813 (Juda), which provides an acidic environment that dissolves mineral scale. However, such polarity reversal does not substantially change the ion exchange capacity of the membranes or ion exchange materials.

Devices called ion-binding electrodes (IBE's) combine the benefits of conventional batch ion exchange processes with electrochemical regeneration, as disclosed in U.S. Pat. No. 5,019,235 (Nyberg), U.S. Pat. No. 4,888,098 (Nyberg), and U.S. Pat. No. 5,007,989 (Nyberg). IBE's typically comprise conductive polymer electrodes, surrounded by and secured to monopolar ion exchange membranes. IBE's operate in batch-mode and provide good ion exchange selectivity, for example the extraction of multivalent ions from solutions containing large concentrations of monovalent ions (e.g., water softening or copper ion extraction processes). Mineral scale fouling of IBE membranes is reduced during the electrochemical regeneration step which involves the production of H⁺ by water electrolysis. Third, concentrated regenerant effluents may be obtained using IBE devices, facilitating either the recovery of ions in the effluent or its disposal as waste. Furthermore, device design and manufacturing complexity is significantly lower for IBE devices as compared to electrodialysis systems because they operate with a single solution stream, and the ion exchange membranes are supported on electrodes. In contrast, the thin, flexible monopolar membranes used in electrodialysis must be carefully positioned using spacers to obtain efficient ion removal and maintain separation of the two solution streams. IBE cells, however, have two significant drawbacks. They require that the cation and anion exchange membranes are secured to opposite sides of an electrode, thereby increasing cell cost and size, and the electrolysis of water forms hydrogen and oxygen gases which may either damage the interface between the electrode and membranes or interfere with solution flow through the cell.

Electrochemical cells comprising water-splitting ion exchange membranes for production of acids and bases from a variety of salt solutions are disclosed in for example U.S. Pat. No. 2,829,095 (Oda), U.S. Pat. No. 4,024,043 (Dege), and U.S. Pat. No. 4,107,015 (Chlanda).

These are continuously operated cells which again necessarily comprise two solution streams, in this case two product streams: one an acid solution and the other a base solution. To operate, these cells must comprise monopolar ion exchange membranes to separate the two solution streams. For example, the water-splitting membrane apparatus described in U.S. Pat. No. 2,829,095 (Oda), suitable for the continuous production of HCl and NaOH from the influent NaCl, for example, is comprised of an anion exchange membrane and a cation exchange membrane positioned between each pair of water-splitting membranes of the cell. In the absence of the monopolar membranes, product effluents HCl and NaOH would mix to form water and NaCl, preventing the cell from functioning.

An alternative design and application of an electrochemical cell comprising water-splitting membranes for the continuous removal of ions from a solution stream is described in U.S. Pat. No. 3,654,125 (Leitz). This is a variant of the continuous electrodialysis cell that employs water-splitting membranes rather than monopolar ion exchange membranes to create two separate solution streams: one the product stream from which ions are removed, and the other the waste stream into which ions are concentrated. The anion exchange layers or surfaces of the water-splitting membranes are oriented in the cell to face each other, as are the cation exchange layer surfaces. Only with this orientation can the peculiar NaCl permselectivity characteristics of water-splitting membranes be exploited for the continuous electrodialysis separation process. The Leitz cell and process has the same drawbacks described for the electrodialysis process including poor ion selectivity, susceptibility to fouling by mineral scale or biological growths, and production of considerable water waste volumes. Furthermore, the Leitz cell and process is largely limited to the treatment of NaCl solutions.

Also due to their continuous operation, the water-splitting membrane cells of the prior art, both the acid/base production cells and the ion removal cell of Leitz, share the characteristic that the water-splitting membranes comprise a combination of strong-acid sulfonate and strong-base quaternary ammonium ion exchange layers rather than employing other ion exchange materials. This particular combination provides membranes having particularly low electrical resistance and high permselectivity.

U.S. Pat. No. 5,788,826 A (Eric Nyberg, 1998) provides ion exchange apparatus and method which provide the benefits of batch ion exchange processes including high ion selectivity, resistance to mineral scale fouling, and concentrated regenerant effluent solutions and an apparatus and method for the regeneration of ion exchange materials which use electrical power rather than introducing chemicals for regeneration. This eliminates the inconvenience and environmental hazards associated with regenerant chemicals and reduces rinse water volumes and avoids the contamination of regenerant effluent solutions with chemicals. However, the invention has some drawbacks such as when the invention is used for water treatment it could only remove ionic pollutants but not neutral pollutants, such as particles, pesticide, VOCs. Therefore, there is a need of a device and a process to address these drawbacks.

CN113402079 A (Foshan Viomi, 2021) discloses household water purifying device comprising pre- and post-filters and at least two electrochemical cells connected in parallel. Each cell contains a water-splitting ion exchange membrane. There are several valves to regulate the flow of water. When the single-flow-channel desalination assembly is used for flushing and regenerating, water purification can be carried out through other single-flow-channel desalination assemblies, so that continuous production of pure water is realized.

CN113402084 A (Foshan Viomi, 2021) discloses household water purifying device comprising pre- and post-filters and at least two electrochemical cells connected in series. Each cell contains a water-splitting ion exchange membrane. There are several valves to regulate the flow of water. When the single-flow-channel desalination assembly is used for flushing and regenerating, water purification can be carried out through other single-flow-channel desalination assemblies, so that continuous production of pure water is realized.

### SUMMARY OF THE INVENTION

First aspect of the present invention provides water treatment device comprising:
a) a first inlet (2A) feeding water into line L₀;
b) a prefiltration unit (10);
c) an electrochemical cell assembly (20) capable of removing ions from a solution stream, the assembly comprising of a Unit-I, comprising at least two electrochemical cells (EC-I, EC-II) connected in parallel with each other, and a Unit-II, comprising of least one electrochemical cell connected in series to the Unit-1, each cell (20) comprising:
   (i) a housing (25) having first (40) and second (45) electrodes;
   (ii) at least one water-splitting ion exchange membrane (100) positioned between the electrodes (40, 45), the water-splitting membrane (100) comprising (i) a cation exchange surface (105) facing the first electrode (40), and (ii) an anion exchange surface (110) facing the second electrode (45); and
   (iii) a solution stream pathway defined by the water-splitting membrane (100), the solution stream pathway (121) having (i) an inlet for influent solution stream, (ii) at least one channel that allows influent solution stream to flow past at least one surface of the water-splitting membrane (100) to form one or more treated solution streams, and (iii) a single outlet that combines the treated solution streams to form a single effluent solution;
   wherein the line L₀ branches into lines L₁ and L₂ at point M to allow passage of water through Unit-I, L₁ leading to EC-I and L₂ leading to EC-II respectively, the lines L₁ and L₂ merge back into line L₀ at point N; and
   wherein Unit-II is positioned downstream of point N; wherein Unit-1 and Unit-2 can be positioned interchangeably; wherein each cell is capable of operating in two stages, deionization stage and regeneration state;
d) a second inlet (2B) for feeding water into line FL during regeneration state of the electrochemical cells, wherein FL feeds water into Unit-I and Unit-II through lines FL12 and FL3 respectively; wherein line FL12 further branches into lines FL1 and FL2 to feed water into EC-I and EC-II respectively;
e) a wastewater line (WL) for discarding wastewater from the two units Unit-I and, Unit-II;
f) a carbon filtration unit (17) positioned downstream of the electrochemical cell assembly (20);
g) an outlet (5A) for dispensing treated water; and
h) an outlet (5B) for discarding wastewater during regeneration stage of one or more of electrochemical cells.

Second aspect of the present invention provides method of treating water according to device of first aspect, the method comprising steps of:
(i) allowing the water to filter through the prefiltration unit (10);
(ii) replacing ions in an ion exchange material of an electrochemical cell assembly (20), of a Unit-I, comprising at least two electrochemical cells (EC-I, EC-II) connected in parallel with each other, and a Unit-II, comprising of least one electrochemical cell connected in series to the Unit-1, each cell (20) comprising:
   a) first and second electrodes (40, 45);
   b) at least one water-splitting membrane between the electrodes, each at least one water-splitting membrane (100) between the electrodes (40, 45), each water-splitting membrane (100) comprising ion exchange layers A and B, one a cation exchange layer facing the first electrode (40) and the other an anion exchange layer facing the second electrode (45), which layers contain ions I_{1A} and I_{1B} respectively;
      wherein a unitary and contiguous solution channel is defined by the cation and anion exchange layer surfaces (105, 110) of the membranes, the solution channel (122) abutting both electrodes (40, 45) and extending continuously from the inlet (30) to the outlet (35) of the housing (25);
   c) an ion-containing solution electrically connecting the electrodes (40, 45) and the water-splitting membranes (100); and in which cell ions I_{1A} and I_{1B} are replaced by ions I_{2A} and I_{2B}, respectively;
   wherein the water-splitting membranes (100) are arranged to provide a continuous channel (122) that allows a stream of solution to flow past both the cation and anion exchange layer surfaces (105, 110) of the water-splitting membranes (100).
   wherein the solution in at least one channel (122) of the cell (20) is simultaneously exposed to a cation and an anion exchange layer surface (105, 110) of water-splitting membranes (100); and
(iii) allowing the water from the electrochemical cell assembly (20) to be filtered by the carbon filtration unit (17); and
(iv) dispensing from the outlet (5A) during the deionization state;
   wherein at a given point in time, at least one electrochemical cell is in the state of regeneration state;
   wherein the cell which is in state of repolarization allows water to flow from feed water line FL into one of respective feed water line FL1, FL2 or FL3 in opposite direction with respect to flow of water during the deionization state; and water exiting from the electrochemical cell which is in the state of repolarization is discarded through wastewater line WL through one of the respective wastewater lines WL1, WL2 or WL3.

### BRIEF DESCRIPTION OF DRAWINGS

FIG. 1 is a schematic representation of water flow in the water treatment device of first aspect;

FIG. 2 is a schematic sectional side view of an embodiment of the electrochemical cell of the present invention;

FIG. 3 is a schematic sectional diagram of a water-splitting ion exchange membrane showing the anion and cation exchange surfaces; and

FIG. 4 is a schematic sectional diagram of another embodiment of a water-splitting ion exchange membrane comprising multiple cation and anion exchange layers.

### DETAILED DESCRIPTION OF THE INVENTION

The present invention provides a water treatment device comprising an electrochemical cell assembly and methods for removing ions present in solutions and replacing ions in ion exchange materials.

The present invention provides water treatment device in accordance with claim 1.

The present inventors surprisingly found that the water treatment device of the present invention provided high salt removal rate with high flow rate and lower feed water pressure. It was also found that the device of present invention provided unexpectedly high water recovery.

The device does not make noise as water flows between the membrane and pump is not necessary for this device. The device also has a longer lifetime as compared to a regular RO device for water purification. The device of the present invention was found to be even superior to the device with electrochemical cells in series as the pressure drop of the latter system was much higher than the pressure-drop seen in the present device. The device of the present invention was also observed to have higher salt removal rate than that compared to electrochemical cell cartridges connected in parallel.

Throughout the description of the invention the terms “regeneration” and “reverse polarization” are used interchangeably and intended to mean the same.

The term “electrochemical cell” or “electrochemical cell cartridge” or the term “electrochemical cell assembly” means to include an assembly of at least one electrochemical cell.

The present invention provides a water treatment device comprising an electrochemical ion exchange system comprising:
(i) the electrochemical cells of first aspect connected according to the first aspect;
(ii) a voltage supply for supplying a voltage to the first and second electrodes; and
(iii) means for flowing an influent solution stream through the cell.

It is preferred that in the electrochemical ion exchange system of the present invention, the water-splitting membranes are positioned so that an electric field generated by the electrodes upon application of a voltage by the voltage supply is directed substantially transverse to the anion and cation exchange surfaces of the water-splitting membranes.

The present invention provides a water treatment device having a first inlet leading to a first feeding line which is in fluid communication with a prefilter which allows the raw or unfiltered water to filter through a prefiltration unit which functions to remove suspended solids, for example particles, rust, colloid. The water line exiting from the prefiltration unit L₀ is divided into lines L₁ and L₂ at point M to supply water from the prefiltration unit to Unit-I comprising at least two electrochemical cells such as EC-I and EC-II which are positioned parallelly to each other and lines L1 and L2 provide water to each of the cells in a parallel manner.

Preferably a valve V1 is positioned downstream of the prefiltration unit and upstream of point M.

Line L₁ leads to EC-I and L2 leads to EC-II. Downstream of EC-I and EC-II, L1 and L2 merge back at point N into line L₀.

EC-III is positioned downstream of point N and a carbon filtration unit is positioned further downstream of EC-III.

Treated water is dispensed through treated water outlet and preferably a valve V2 is positioned downstream of the carbon filtration unit and upstream of the treated water outlet.

It is preferred that the water treatment system operates in two states, deionization state and reverse polarization or regeneration state.

A second feed line FL is provided through a second inlet for supplying the feed water to the respective units/cells when they are at reverse polarization state.

The FL supplies water to Units-I and II through lines FL12 and FL3, branching at point S. FL12 supplies water to Unit-I and FL3 supplies water to Unit-II. FL12 branches into lines FL1 and FL2 at point P.

The FL branches into lines FL12 and FL3 to supply water to Unit-I and Unit-II respectively preferably at point S. Line FL12 further divides into lines FL1 and FL2 to supply water to EC-I and EC-II respectively; whereas FL3 preferably supplies water to EC-III.

FL1 is operably functional through a valve FLV1 so that the line is operational only when EC-I is in regeneration state.

FL2 is operably functional through a valve FLV2 so that the line is operational only when EC-II is in regeneration state.

FL3 is operably functional through a valve FLV3 so that the line is operational only when EC-III is in regeneration state. It is preferred that line FL3 merges into line L₀ downstream of EC-III.

A wastewater line WL is provided for discarding the wastewater from the respective cells when they are at reverse polarization/regeneration state. It is preferred that the water is discarded from the electrochemical cells during the regeneration stage and EC-I discards water into WL1 preferably, operably through valve WLV1, EC-II discards water into WL2, preferably, operably through valve WLV2, and EC-III discards water into WL3, preferably, operably through valve WLV3. At a time only one of the valves among WLV1, WLV2 and WLV3 are open. All valves WLV1, WLV2 and WLV3 drain water into line WL and preferably the water from WL is discarded through the wastewater outlet.

It is preferred that lines WL1, preferably downstream of WLV1 and WL2 preferably downstream of WLV2 merge into line WL at point O and further preferred that WL3 also merges into line WL downstream of valve WLV3.

The electrochemical cells are regenerated one at a time. Valves V1 and V2 are closed when anyone of the cells is being regenerated.

When EC-I is in a state of regeneration, valves FLV, FLV1 and WLV1 are open and rest of the valves are closed. This allows water for regeneration to enter from second feed water inlet into line FL and line FL12 into line FL1 through valve FLV1, the cell then undergoes the regeneration process by reversing of polarity. The wastewater produced during this process is drained into wastewater line WL1 and through the valve WLV1 into the main waste water line WL and discarded through the waste water outlet.

When EC-II is in a state of regeneration, valves FLV, FLV2 and WLV2 are open and rest of the valves are closed. This allows water for regeneration to enter from second feed water inlet into line FL and line FL12 into line FL2 through valve FLV2, the cell then undergoes the regeneration process by reversing of polarity. The wastewater produced during this process is drained into wastewater line WL2 and through the valve WLV2 into the main wastewater line WL and discarded through the wastewater outlet.

When EC-III is in a state of regeneration, valves FLV, FLV3 and WLV3 are open and rest of the valves are closed. This allows water for regeneration to enter from second feed water inlet into line FL and line FL12 into line FL3 through valve FLV3, the cell then undergoes the regeneration process by reversing of polarity. The wastewater produced during this process is drained into wastewater line WL3 and through the valve WLV3 into the main wastewater line WL and discarded through the wastewater outlet.

It is preferred that the regeneration of Unit-I and Unit-II or the electrochemical cells is triggered when a predetermined volume of water is treated. It is preferred that a flow sensor is positioned before the valve V2 and after the predetermined volume of water is sensed through it, the process of water treatment for dispensing through the treated water outlet is stopped and the Units-I and II enter into the stage of regeneration, the electrochemical cells enter the state of regeneration, one at a time. It is further preferred that each cell is in the state of regeneration for a predetermined amount of time.

The present invention provides a water treatment device comprising an electrochemical cell capable of removing ions from a solution stream, the cell comprising:
1) a housing having first and second electrodes;
2) at least one water-splitting ion exchange membrane positioned between the electrodes, the water-splitting membrane comprising (i) a cation exchange surface facing the first electrode, and (ii) an anion exchange surface facing the second electrode; and
3) a unitary and contiguous solution channel that allows an influent solution stream to flow past (i) the electrodes, and (ii) both the cation and anion exchange surfaces of the water-splitting membrane.

The present invention provides a water treatment device at least three electrochemical cells capable of removing ions from a solution stream, connected according to the first aspect, the cells comprising:
a housing having first and second electrodes;
at least one water-splitting ion exchange membrane positioned between the electrodes, the water-splitting membrane comprising (i) a cation exchange surface facing the first electrode, and (ii) an anion exchange surface facing the second electrode; and
a solution stream pathway defined by the water-splitting membrane, the solution stream pathway having (i) an inlet for influent solution stream, (ii) at least one channel that allows influent solution stream to flow past at least one surface of the water-splitting membrane to form one or more treated solution streams, and (iii) a single outlet that combines the treated solution streams to form a single effluent solution.

The present invention also provides a water treatment device an electrochemical cell assembly capable of removing ions from a solution stream, the assembly comprising of at least three electrochemical cells (EC), each cell comprising:
1) a housing having first and second electrodes;
2) at least one water-splitting ion exchange membrane positioned between the electrodes, the water-splitting membrane comprising:
   a cation exchange surface facing the first electrode, and
   an anion exchange surface facing the second electrode; and
3) a unitary and contiguous solution channel that allows an influent solution stream to flow past (i) the electrodes, and (ii) both the cation and anion exchange surfaces of the water-splitting membrane.

The present invention also provides a water treatment device comprising an assembly of electrochemical cells for selectively removing multivalent ions from a solution, the assembly comprising:
a) a first electrochemical cell including:
   (i) two electrodes,
   (ii) at least one water-splitting ion exchange membrane between the electrodes, each water-splitting membrane comprising a cation exchange surface facing the first electrode, and an anion exchange surface facing the second electrode, and
   (iii) a first solution stream pathway having (i) an inlet for influent solution stream, (ii) at least one channel that allows influent solution stream to flow past at least one surface of the water-splitting membrane to form one or more treated solution streams, and (iii) a single outlet that combines the treated solution streams to form a first effluent solution;
b) at least one second electrochemical cell comprising:
   (i) two electrodes,
   (ii) at least one water-splitting ion exchange membrane between the electrodes, each water-splitting membrane comprising a cation exchange surface facing the first electrode, and an anion exchange surface facing the second electrode, and
   (iii) a second solution stream pathway having (i) an inlet for influent solution stream, (ii) at least one channel that allows influent solution stream to flow past at least one surface of the water-splitting membrane to form one or more treated solution streams, and (iii) a single outlet that combines the treated solution streams to form a second effluent solution;
c) means for supplying a voltage to the electrodes of the first and second cells; and
d) a flow controller for apportioning a flow of a solution stream into the first and second cells so that the solution stream flows into the first cell at a first flow rate and into the second cell at a second flow rate, the first and second flow rates being selected to provide a desired concentration of multivalent ions in the combined first and second effluent solutions.

It is preferred that in the electrochemical cell the solution stream pathway comprises a unitary and contiguous solution channel that flows past both the cation and anion exchange surfaces of the water-splitting membrane.

It is preferred that in the electrochemical cell the solution stream pathway comprises a unitary and contiguous solution channel that is connected throughout in an unbroken sequence and extends substantially continuously from the inlet to the outlet.

It is preferred that the electrochemical cell comprises substantially no monopolar ion exchange membranes.

It is preferred that the electrochemical cell comprises a plurality of water-splitting membranes, and wherein the solution stream pathway comprises a unitary and contiguous solution channel that flows past (i) the electrodes, and (ii) both the cation and anion exchange surfaces of each water-splitting membrane.

It is preferred that the electrochemical cell comprises a plurality of water-splitting membranes, and wherein the solution stream pathway comprises a plurality of channels, each channel allowing the influent solution to flow past cation and anion exchange surfaces of adjacent water-splitting membranes.

It is preferred that the electrochemical cell comprises substantially no monopolar ion exchange membranes between the adjacent water-splitting membranes.

It is preferred that the electrochemical cell comprises a plurality of interdigited water-splitting membranes having alternating ends attached to the housing.

It is preferred that in the electrochemical cell of the present invention the water-splitting membranes are rolled in a spiral arrangement to form a cylindrical shape, and (ii) the first or second electrode comprises a cylinder enclosing the spiral arrangement of water-splitting membranes.

It is preferred that in the electrochemical cell the solution stream pathway allows the influent solution stream to flow past both the cation and anion exchange layer surfaces of the water-splitting membranes in the direction of the spiral.

It is preferred that in the electrochemical cell the water-splitting membrane comprises at least one of the following characteristics:
a) a cation exchange surface comprising a chemical group selected from the group consisting of —SO₃M, —COOM, —PO₃M₂, —C₆H₄OM, aliphatic amines, aromatic amines, aliphatic phosphines, aromatic phosphines, aliphatic sulfides, aromatic sulfides, aminophosphoric acid, aminocarboxylic acid, hydroxamic acid, and mixtures thereof, where M is a cation;
b) an anion exchange surface comprising a chemical group selected from the group consisting of aliphatic amines, aromatic amines, aliphatic phosphines, aromatic phosphines, aliphatic sulfides, aromatic sulfides, and mixtures thereof;
c) at least one exchange surface of each water-splitting membrane comprises an average pore size of at least about 1 micron;
d) at least one exchange surface of each water-splitting membrane comprises a pore volume of at least 10 volume %; or
e) the membranes are heterogeneous and comprise cross-linked water-swellable polymeric host material.

It is preferred that in the electrochemical cell the cation exchange surfaces of the water-splitting membranes comprise at least two cation exchange layers each comprising different cationic chemical groups.

It is preferred that in the electrochemical cell an inner cation exchange layer comprises SO₃⁻ chemical groups, and an outer cation exchange layer comprises an ion exchange chemical group other than SO₃⁻.

It is preferred that in the electrochemical cell the anion exchange surfaces of the water-splitting membranes comprise at least two anion exchange layers each comprising different cationic chemical groups.

It is preferred that in the electrochemical cell an inner anion exchange layer comprises NR₃⁺ groups, and an outer anion exchange layer comprises ion exchange groups other than NR₃⁺, where R is selected from the group consisting of aliphatic hydrocarbons, aliphatic alcohols, and aromatic hydrocarbons.

### Method

The invention also relates to a method of treating water according to claim 1.

It is preferred that voltage is applied to the electrochemical cell for a better ion exchange speed and increased salt removal rate.

The present invention also provides a method using the device of the present invention for replacing ions in an ion exchange material of an electrochemical cell assembly comprising at least three electrochemical cells (EC), each cell comprising:
a) first and second electrodes;
b) at least one water-splitting membrane between the electrodes, each water-splitting membrane comprising ion exchange layers A and B, one a cation exchange layer facing the first electrode and the other an anion exchange layer facing the second electrode, which layers contain ions I_{1A} and I_{1B} respectively;
   wherein a unitary and contiguous solution channel is defined by the cation and anion exchange layer surfaces of the membranes, the solution channel abutting both electrodes and extending continuously from the inlet to the outlet of the housing;
c) an ion-containing solution electrically connecting the electrodes and the water-splitting membranes;
   in which cell ions I_{1A} and I_{1B} are replaced by ions I_{2A} and I_{2B}, respectively;

The present invention also provides a method for removing multivalent ions from a solution, which method comprises applying a voltage to an assembly comprising first and second electrochemical cells:
a) the first electrochemical cell comprising:
   (i) first and second electrodes;
   (ii) at least one water-splitting membrane between the electrodes, each water-splitting membrane comprising a cation exchange layer A and an anion exchange layer B, which layers comprise ions I_{4A} and I_{4B}, respectively, ions I_{4A} and I_{4B} comprising substantially H⁺ and OH⁻, respectively, wherein the cation exchange layers face the first electrode and the anion exchange layers face the second electrode, in which cell there is a unitary and contiguous solution channel, and
   (iii) a solution containing ions I_{2A} and I_{2B} which electrically connects the electrodes and water-splitting membrane, in which cell ions I_{4A} and I_{4B} are replaced by ions I_{2A} and I_{2B};
b) a second electrochemical cell, comprising:
   (i) first and second electrodes;
   (ii) at least one water-splitting membrane arranged between the electrodes, each water-splitting membrane comprising a cation exchange layer A and an anion exchange layer B, which layers comprise ions I_{5A} and I_{5B}, respectively, ions I_{5A} and I_{5B} comprising monovalent ions other than H⁺ and OH⁻, respectively, wherein the cation exchange layers face the first electrode and the anion exchange layers face the second electrode, in which cell there is a unitary and contiguous solution channel, and
   (iii) a solution containing ions I_{2A} and I_{2B} which electrically connects the electrodes and water-splitting membrane, in which cell ions I_{5A} and I_{5B} are replaced by ions I_{2A} and I_{2B}, respectively.

It is preferred that in the method of present invention the cell comprises substantially no monopolar ion exchange membranes.

It is preferred that in the method of present invention the water-splitting membranes are arranged to provide a continuous channel that allows a stream of solution to flow past both the cation and anion exchange layer surfaces of the water-splitting membranes.

It is preferred that in the method of present invention the solution in at least one channel of the cell is simultaneously exposed to a cation and an anion exchange layer surface of water-splitting membranes.

It is preferred that in the method of present invention wherein H⁺ and OH⁻ are produced within the water-splitting membranes and pass-through ion exchange layers A and B, respectively, causing ions I_{1A} and I_{1B} to be replaced by ions I_{2A} and I_{2B} respectively.

It is preferred that in the method of present invention the polarities of ions I_{1A} and I_{1B} are the same as those of the H⁺ and OH⁻ ions causing their replacement.

It is preferred that in the method of present invention polarities of ions 11A and 18 are opposite those of the H⁺ and OH⁻ ions causing their replacement.

It is preferred that the method of present invention comprises the additional step of reversing the polarity of the electrodes causing ions I_{2A} and I_{2B} to be replaced by ions I_{3A} and I_{3B}, respectively.

It is preferred that in the method of present invention in the reversing step, the OH⁻ and H⁺ are produced within the water-splitting membranes and pass through ion exchange layers A and B, respectively, causing ions I_{2A} and I_{2B} to be replaced by ions I_{3A} and I_{3B}, respectively.

It is preferred that the method of present invention comprises the additional step of terminating the current, causing ions I_{2A} and I_{2B} to be replaced by ions I_{3A} and I_{3B}, respectively.

It is preferred that in the method for removing multivalent ions from a solution comprises the additional step of introducing another solution into the second electrochemical cell and reversing the polarity of the electrodes causing ions I_{2A} and I_{2B} to be replaced by ions I_{4A} and I_{4B}, respectively.

It is preferred that in the method for removing multivalent ions from a solution, in both cells the water-splitting membranes are arranged to provide a continuous solution stream in each cell which flows past both the cation and anion exchange layer surfaces of their water-splitting membranes.

It is preferred that in the method for removing multivalent ions from a solution the solution in at least one channel of the first and second cells is simultaneously exposed to a cation and an anion exchange layer surface of water-splitting membranes.

It is preferred that in the method for removing multivalent ions from a solution the step of flowing a solution stream through the first and second cells includes the step of controlling the flow rates of the solution through the first and second cells to obtain a predetermined concentration of ions in the effluent streams from the cells.

It is preferred that in the method for removing multivalent ions from a solution the step of controlling the flow rates of the solution through the first and second cells to obtain a predetermined concentration of ions in effluent streams from the cells includes the step of monitoring the composition of the effluent streams from the first and second cells, and adjusting the flow rates of the solution through the first and second cells in relation to the composition of the effluent streams.

It is preferred that the method for removing multivalent ions from a solution comprises a third electrochemical cell comprising:
(a) first and second electrodes;
(b) at least one water-splitting membrane arranged between the electrodes, each water-splitting membrane comprising a combination of a cation exchange layer A and an anion exchange layer B, which layers comprise ions 12A and 12B, wherein the cation exchange layers face the first electrode and the anion exchange layers face the second electrode, in which cell there is a unitary and contiguous solution stream, and
(c) a solution which electrically connects the electrodes and water-splitting membranes, wherein the polarity of the first and second electrodes in the third cell is reversed relative to that for the first and second cells, such that in the third cell ions I_{2A} and I_{2B} are replaced by ions I_{4A} and I_{4B}, respectively.

It is preferred that in the method for removing multivalent ions from a solution the replacement of ions I_{2A} and I_{2B} by ions I_{4A} and I_{4B}, respectively, in the third cell occurs while the first and second cells are removing multivalent ions from their separate solution stream.

It is preferred that the prefiltration unit includes polypropylene sediment filter, microfiltration filter, ultrafiltration filter and combinations thereof.

The ultrafiltration unit of the present invention preferably comprises of at least two chambers and preferably four chambers which allows the water to flush quicker when the flux is same and therefore results in longer lifetime compared with traditional ultrafiltration unit. It is preferred that the ultrafiltration unit is washed regularly to remove the particulates and colloid resulting in prolonged lifetime of the device.

The ultrafiltration unit is preferably positioned upstream of the electrochemical cell assembly and preferably downstream of the inlet of the water treatment device.

The ultrafiltration unit preferably functions to filter out the suspended solids, larger particles, colloidal matter and proteins from water through an ultrafiltration membrane. It is preferred that the ultrafiltration unit also removes bacteria, protozoa and some viruses from the water

The carbon filter is preferably used to remove pollutants which cannot be removed by ultrafiltration unit and electrochemical cell. It is preferred that the carbon filter is an activated carbon filter. The carbon filter could be selected from VOC removal carbon, heavy metal removal carbon, sterilizing/antibacterial carbon, broad-spectrum carbon, Vitamin C filter, herbal filter, strontium-carbon filter, or any other mineral-containing carbon filter.

It is preferred that the carbon filter is positioned downstream of the electrochemical cell assembly and more preferably the water is dispensed after exiting from the carbon filter for use.

It is preferred that in the method of present invention when the EC-I is in regeneration stage, water enters into EC-I from feed line FL through line FL1 after passing through EC-I, the water enters into line WL1 and is discarded into the waste water outlet 5B through waste water line WL.

It is preferred that in the method of present invention when the EC-II is in regeneration stage, water enters into EC-II from feed line FL through line FL2 after passing through EC-I, the water enters into line WL2 and is discarded into the waste water outlet 5B through waste water line WL.

It is preferred that in the method of present invention when the EC-III is in regeneration stage, water enters into EC-III from feed line FL through line FL3 after passing through EC-I, the water enters into line WL3 and is discarded into the waste water outlet 5B through waste water line WL.

In the method of the present invention the electrochemical cells are regenerated one at a time. It is further preferred that valves V1 and V2 are closed when anyone of the cells is being regenerated.

It is preferred that in the method of the present invention when EC-I is in a state of regeneration, valves FLV, FLV1 and WLV1 are open and rest of the valves are closed. This allows water for regeneration to enter from second feed water inlet into line FL and line FL12 into line FL1 through valve FLV1, the cell then undergoes the regeneration process by reversing of polarity.

The waste water produced during this process is drained into waste water line WL1 and through the valve WLV1 into the main waste water line WL and discarded through the waste water outlet.

It is preferred that in the method of the present invention when EC-II is in a state of regeneration, valves FLV, FLV2 and WLV2 are open and rest of the valves are closed. This allows water for regeneration to enter from second feed water inlet into line FL and line FL12 into line FL2 through valve FLV2, the cell then undergoes the regeneration process by reversing of polarity. The waste water produced during this process is drained into waste water line WL2 and through the valve WLV2 into the main waste water line WL and discarded through the waste water outlet.

It is preferred that in the method of the present invention when EC-III is in a state of regeneration, valves FLV, FLV3 and WLV3 are open and rest of the valves are closed. This allows water for regeneration to enter from second feed water inlet into line FL and line FL12 into line FL3 through valve FLV3, the cell then undergoes the regeneration process by reversing of polarity. The waste water produced during this process is drained into waste water line WL3 and through the valve WLV3 into the main waste water line WL and discarded through the waste water outlet.

It is preferred that in the method of the present invention the regeneration of Unit-I and Unit-II or the electrochemical cells is triggered when a predetermined volume of water is treated. It is preferred that a flow sensor is positioned before the valve V2 and after the predetermined volume of water is sensed through it, the process of water treatment for dispensing through the treated water outlet is stopped and the Units-I and II enter into the stage of regeneration, it is further preferred that the electrochemical cells enter the state of regeneration, one at a time. It is preferred that each electrochemical cell is in a state of regeneration for a predetermined period of time.

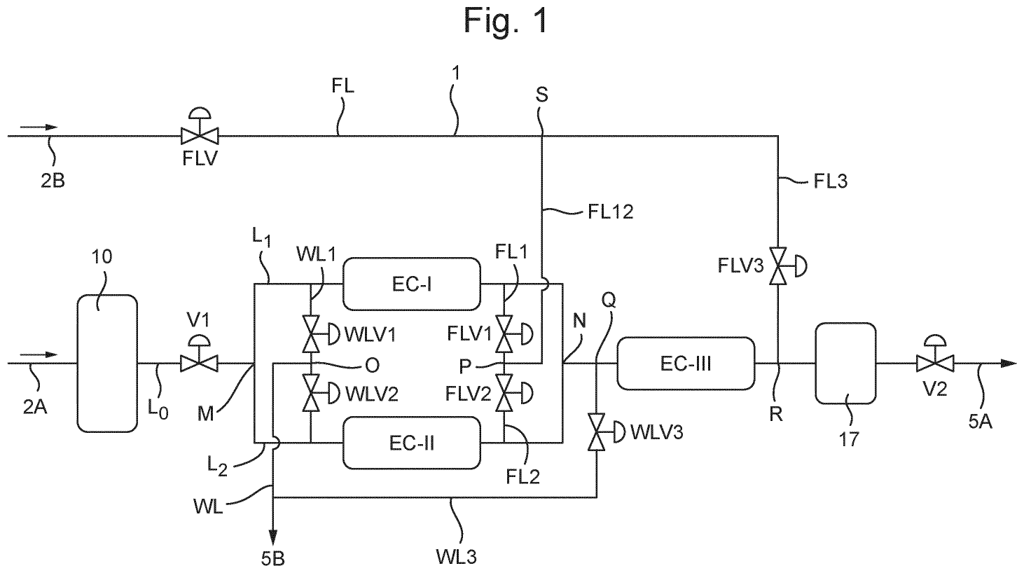

FIG. 1 presents the flow diagram of water treatment device 1 of the present invention comprising a first inlet (2A) feeding water into line L₀; a prefiltration unit (10); an electrochemical cell assembly (20) capable of removing ions from a solution stream, the assembly comprising of a Unit-I, comprising at least two electrochemical cells (EC-I, EC-II) connected in parallel with each other, and a Unit-II, comprising of least one electrochemical cell connected in series to the Unit-1, each cell (20) comprising: a housing (25) having first (40) and second (45) electrodes; at least one water-splitting ion exchange membrane (100) positioned between the electrodes (40, 45), the water-splitting membrane (100) comprising (i) a cation exchange surface (105) facing the first electrode (40), and (ii) an anion exchange surface (110) facing the second electrode (45); and a solution stream pathway defined by the water-splitting membrane (100), the solution stream pathway (121) having (i) an inlet for influent solution stream, (ii) at least one channel that allows influent solution stream to flow past at least one surface of the water-splitting membrane (100) to form one or more treated solution streams, and (iii) a single outlet that combines the treated solution streams to form a single effluent solution; wherein the line L₀ branches into lines L₁ and L₂ at point M to allow passage of water through Unit-1, L₁ leading to EC-I and L₂ leading to EC-II respectively, the lines L₁ and L₂ merge back into line L₀ at point N; and wherein Unit-II is positioned downstream of point N; wherein Unit-1 and Unit-2 can be positioned interchangeably; and wherein each cell is capable of operating in two stages, deionization stage and regeneration state; a second inlet (2B) for feeding water into line FL during regeneration state of the electrochemical cells, wherein FL feeds water into Unit-I and Unit-II through lines FL12 and FL3 respectively; wherein line FL12 further branches into lines FL1 and FL2 to feed water into EC-I and EC-II respectively; a wastewater line (WL) for discarding wastewater from the two units Unit-I and, Unit-II; a carbon filtration unit (17) positioned downstream of the electrochemical cell assembly (20); an outlet (5A) for dispensing treated water; an outlet (5B) for discarding waste water during regeneration stage of one or more of electrochemical cells.

The water treatment device as shown in the figure has a first inlet (2A) leading to a first feeding line L₀ which is in fluid communication with a prefilter (10) which allows the raw or unfiltered water to filter through a prefiltration unit (10) which functions to remove suspended solids, for example particles, rust, colloid and etc. the water line L₀ exiting from the prefiltration unit is preferably divided into lines L₁ and L₂ at point M to supply water from the prefiltration unit to Unit-I comprising at least two electrochemical cells such as EC-I and EC-II which are positioned parallelly to each other and lines L₁ and L₂ provide water to each of the cells in a parallel manner.

A valve V1 is positioned downstream of the prefiltration unit (10) and upstream of point M. Line L₁ leads to EC-I and L2 leads to EC-II. Downstream of EC-I and EC-II, L1 and L2 merge back at point N into line L₀.

EC-III is positioned downstream of point N and a carbon filtration unit (17) is positioned further downstream of EC-III.

The treated water is dispensed through treated water outlet (5A) and a valve V2 is positioned downstream of the carbon filtration unit (17) and upstream of the treated water outlet (5A).

The water treatment device (1) operates in two states, deionization state and reverse polarization or regeneration state.

A second feed line FL is provided through a second inlet (2B) for supplying the feed water to the respective units/cells when they are at reverse polarization/regeneration state.

The FL supplies water to Units-I and II through lines FL12 and FL3, shown branching at point S.

It is shown that FL12 supplies water to Unit-I and FL3 supplies water to Unit-II and FL12 further branches into lines FL1 and FL2 at point P.

The FL branches into lines FL12 and FL3 to supply water to Unit-I and Unit-II respectively preferably at point S. It is preferred that line FL12 further divides into lines FL1 and FL2 to supply water to EC-I and EC-II respectively; whereas FL3 preferably supplies water to EC-III. FL1 is operably functional through a valve FLV1, FL2 is operably functional through valve FLV2 and FL3 is operably functional through a valve FLV3. It is seen that FL3 merges into line L₀ downstream of EC-III

A wastewater line WL is provided for discarding the waste water from the respective cells when they are at reverse polarization/regeneration state. The water is discarded from the electrochemical cells during the regeneration stage and EC-I discards water into WL1 preferably, operably through valve WLV1, EC-II discards water into WL2, operably through valve WLV2, and EC-III discards water into WL3, operably through valve WLV3. At a given time only one of the valves among WLV1, WLV2 and WLV3 are open. It is seen that all valves WLV1, WLV2 and WLV3 drain water into line WL and the water from WL is discarded through the waste water outlet (5B).

It is also seen that the line WL1, downstream of WLV1 and WL2 downstream of WLV2 merge into line WL at point O and further preferred that WL3 also merges into line WL downstream of valve WLV3.

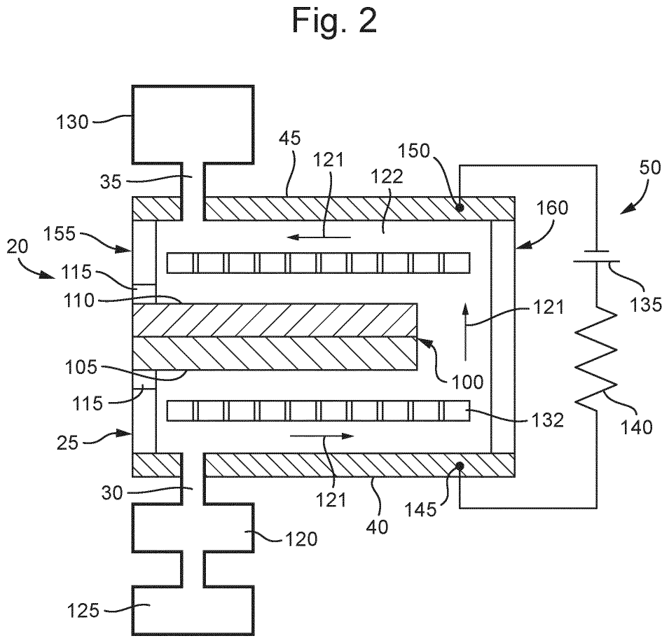

FIG. 2 presents one embodiment of an electrochemical cell assembly 20 of the present invention comprising a housing 25 having at least one inlet 30 for introducing an influent solution stream into the cell, and one outlet 35 that provides a single effluent solution. Opposing first and second electrodes 40, 45 in the cell are powered by electrode voltage supply 50 that supplies a voltage across the electrodes. At least one water-splitting membrane 100 is positioned between the electrodes 40, 45 in the housing 25. Each water-splitting membrane 100 comprises at least one combination of adjacent and abutting cation exchange surface 105 (typically a cation exchange layer having cationic exchange groups) and an anion exchange surface 110 (typically comprising an anion exchange layer having anionic exchange groups).

The water-splitting membranes 100 are arranged in the housing 25 so that the cation exchange surfaces of the membranes face the first electrode 40, and the anion exchange surfaces of the membranes face the second electrode 45.

A solution stream pathway (as represented by the arrows 121) is defined by the surfaces of the water-splitting membranes 100, the electrodes 40, 45, and the sidewalls of the cell. The solution stream pathway 121 (i) extends from the inlet 30 (which is used for introducing an influent solution stream into the solution stream pathway), (ii) includes at least one channel that allows the influent solution stream to flow past at least one surface of the water-splitting membrane to form one or more treated solution streams, and (iii) terminates at a single outlet 35 that combines the treated solution streams to form a single effluent solution. The solution stream pathway 121 can comprise a single serial flow channel extending continuously through the cell, or can comprise a plurality of parallel flow channels that are connected and terminate at a single outlet 35. In the embodiment in FIG. 2, the water-splitting membranes 100 are arranged to provide a solution stream pathway 121 having an unitary and contiguous solution channel 122 that flows past both the cation and anion exchange surfaces of the water-splitting membrane. Preferably, the channel 122 is connected throughout in an unbroken sequence extending continuously from the inlet to the outlet, and flowing past the anion and cation exchange surfaces of the water-splitting membranes. Thus the unitary and contiguous channel's perimeter comprises at least a portion of all the cation and anion exchange layer surfaces of the water-splitting membranes in the cell.

The housing 25 typically comprises a plate and frame construction fabricated from metal or plastic and comprises one or more inlet holes 30 to introduce solution into the cell and one or more outlet holes 35 to remove effluent solution from the cell. While one or more outlet holes can be provided, the effluent solution from the cell preferably comprises a single effluent solution stream that is formed before or after the outlet holes (for example in an exhaust manifold that combines the different solution streams). The water-splitting membranes 100 are held in the housing 25 using gaskets 115 positioned on either side of the water-splitting membrane. A pump 120, such as for example, a peristaltic pump or water pressure in combination with a flow control device, is used to flow solution from a solution source 125 through the channel 122 and into a treated solution tank 130. In this embodiment, the pump 120 serves as means to flow a single solution stream through the cell. An electrode voltage supply 50, typically external to the electrochemical cell 20, comprises a direct current voltage source 135 in series with a resistor 140. The electrical contacts 145, 150 are used to electrically connect the voltage supply 50 to the first and second electrodes 40, 45. Instead of a DC current source, the voltage source can also be a rectified alternating current source, for example, a half-wave or full-wave rectified alternating current source.

The anode and cathode electrodes 40, 45 are fabricated from an electrically conductive material, such as a metal which is preferably resistant to corrosion in the low or high pH chemical environments created during positive and negative polarization of the electrodes during operation of the cell 20. Suitable electrodes can be fabricated from copper, aluminum, or steel cores which are coated with a corrosion-resistant material such as platinum, titanium, or niobium. The shape of the electrodes 40, 45 depends upon the design of the electrochemical cell 20 and the conductivity of the solutions flowing through the cell. The electrodes 40, 45 should provide a uniform voltage across the surfaces of the water-splitting membranes 100, a suitable electrode shape for cell 20 being a flat plate dimensioned approximately as large as the area of the water-splitting membrane, positioned at the top and the bottom of the cell 20, and having an electrode surface interior to the housing. Preferably, the first and second electrodes 40, 45 comprise planar structures on either side of planar water-splitting membranes 100 positioned adjacent to one another. Alternative electrode shapes include distributed designs such as woven screens, expanded meshes, or wire shaped in a particular configuration, for example, a serpentine shape. For source solution to enter and exit cell 20, as for example in the embodiment in FIG. 2, it may be necessary to cut openings in the two electrodes 40 and 45 to allow solution to pass into and out of channel 122.

Preferably, the electrodes 40, 45 are constructed of two or more layers that provide the desired combination of electrical conductivity and corrosion resistance. A suitable configuration comprises an inner electrically conductive layer which has a sufficiently low electrical resistance to provide substantially uniform voltage across water-splitting membranes 100; a corrosion resistant layer to prevent corrosion of the electrically conductive layer; and a catalytic coating on the surface of the electrode to reduce operating voltages, extend electrode life, and minimize power requirements. A preferred electrode structure comprises a copper conductor covered by corrosion-resistant material such a titanium or niobium, and thereafter coated with a noble metal catalyst layer such as platinum.

The gaskets 115 separating the water-splitting membranes 100 in cell 20 and forming its sidewalls 155, 160 have multiple functions. In the first function, the gaskets 115 prevent leakage of the solution through the sidewalls 155, 160 of the cell 20. In another function, the gaskets 115 are made of an electrically insulating material to prevent shorting or divergence of the electrical current channel through the sidewalls 155, 160 of the cell 20. This forces the electrical current channel, or the electrical field between the electrodes 40, 45, to be directed substantially perpendicularly through the plane of the water-splitting membranes 100 to provide more efficient ion removal or replacement. Within solution channel 122 are preferably positioned spacers 132, for example, layers of plastic netting material suspended form the sidewalls of the cell. Spacers 132 serve several functions: they separate water-splitting membranes 100, provide more uniform flow, and create turbulence in the solution stream pathway to provide higher ion transport rates. If two or more water-splitting membranes are in direct contact, excess current may flow through this low resistance path, overheating the membranes and bypassing the solution (thereby reducing cell performance). This spacer may be of any construction having an average pore size or opening greater than 10 μm in diameter. Solution channel 122 in the cell may also comprise ion exchange material particles or filaments, for example beads, granules, fibers, loosely woven structures, or any other structure which allows the solution in the channel 122 to contact both the cation and anion exchange layer surfaces of the water-splitting membranes that form a portion of the periphery of the channel. Any ion exchange material located in channel 122 still provides a single, contiguous solution stream in cell 20. The ion exchange material in channel 122 may comprise cation exchange material, anion exchange material, or a mixture of the two. However, the ion exchange material located in channel 122 should not be in the form of a monopolar ion exchange membrane that separates two or more solution streams in the cell. Thus, the cell preferably comprises substantially no monopolar ion exchange membranes between adjacent water-splitting membranes.

The water-splitting membrane 100 is any structure comprising a cation exchange surface 105 and an anion exchange surface 110 in combination such that under a sufficiently high electric field, produced by application of voltage to electrodes 40 and 45, water is dissociated into its component ions H⁺ and OH⁻ in the membrane. This dissociation occurs most efficiently at the boundary between the cation and anion exchange surfaces or layers in the membrane, or in the volume between them, and the resultant H⁺ and OH⁻ ions migrate through an ion exchange layer in the direction of the electrode having an opposite polarity. For example, H⁺ will migrate toward the negative electrode (cathode), and OH⁻ will migrate toward the positive electrode (anode). Preferably, the water-splitting membrane comprises abutting cation and anion exchange layers 105, 110 that are secured or bonded to each other to provide a water-splitting membrane 100 having a unitary laminate structure. The cation and anion exchange layers 105, 110 can be in physical contact without a bond securing them together, or the water-splitting membrane 100 can include a non-ionic middle layer, for example a water-swollen polymer layer, a porous layer, or a solution-containing layer.

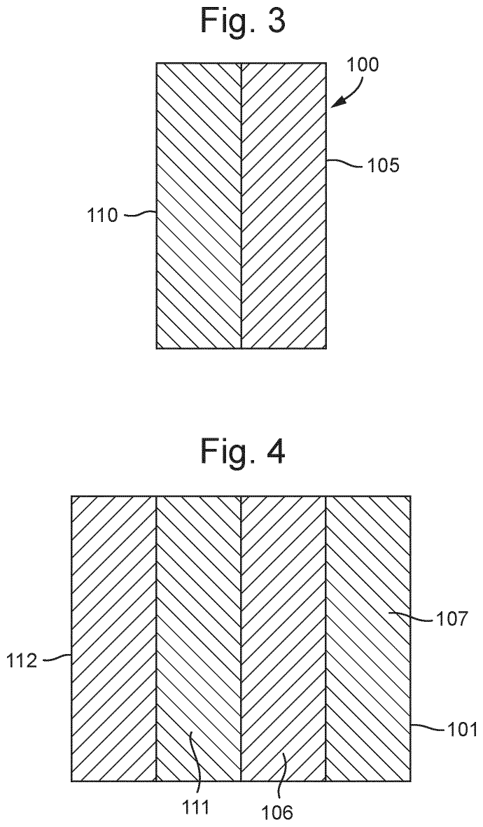

An expanded sectional diagram of an embodiment of a water-splitting membrane 100 comprising abutting cation and anion exchange surfaces or layers is shown in FIG. 3.

Suitable cation exchange layers 105 can comprise one or more acidic functional groups capable of exchanging cations such as —COOM, —SO₃M, —PO₃M₂, and —C₆H₄OM, where M is a cation (e.g., hydrogen, sodium, calcium, or copper ion). Cation exchange materials also include those comprising neutral groups or ligands that bind cations through coordinate rather than electrostatic or ionic bonds (for example pyridine, phosphine and sulfide groups), and groups comprising complexing or chelating groups (e.g., those derived from aminophosphoric acid, aminocarboxylic acid, and hydroxamic acid). The choice of cation exchange functional group depends upon the application of the cell 20. In water deionization for which the non-selective removal of ions is required, —SO₃M groups are preferred for their ability to impart good membrane swelling, high mass transport rates, and low electrical resistances over a wide range of pH. For the selective removal of copper ion from a liquid containing other ions, for example sodium ion, ion exchange groups such as —COOM or a chelating group such as aminocarboxylic acid are preferred. These weak acid groups offer the additional benefit of particularly efficient regeneration due to the strongly favorable reaction of —(COO)ₙM with H⁺ to form —COOH and expel M⁺ⁿ, where M is a metal ion.

Suitable anion exchange layers 110 of water-splitting membrane 100 comprise one or more basic functional groups capable of exchanging anions such as —NR₃A, —NR₂HA, —PR₃A, —SR₂A, or C₅H₅NHA (pyridine), where R is an alkyl, aryl, or other organic group and A is an anion (e.g., hydroxide, bicarbonate, chloride, or sulfate ion). The choice of anion exchange functional group also depends on the application. In water deionization, —NR₃A is preferred for its ability to impart good membrane swelling, and thus provide low electrical resistances and high mass transport rates, over a wide range of pH. Weak base groups are preferred when particularly efficient regeneration is required. For example, —NR₂HA will react with OH in a very favorable reaction to form —NR₂, H₂O, and expel A.

### Example 1

The water treatment device is assembled according to the first aspect of the present invention. A water treatment process was constructed according to the first aspect of the first aspect. An ultrafiltration unit (from Truliva) was used as the pre-filter. Three electrochemical cell cartridges were used as the main salt removal unit. EC-I and EC-II were used in parallel and comprised Unit-I and connected with Unit-II comprising of EC-III in series. Each electrochemical cells is composed of 25 layers 15.6 cm*40 cm electronically regenerated ion exchange membrane and could treat 6 L water (<400 ppm after regeneration). An active carbon filter (From Kortech) was used as the postfilter. Totally, two pieces Ti electrodes were used for each electrochemical cell. A central rising tube was in the electrochemical cell cartridges housing to hold the inner electrode. The other piece was fixed on the inner side of the cartridge housing. A power supply was attached to the 2 pieces of electrode providing an electric field.

During the deionization stage, solenoid valves V1 and V2 were opened, feed water was treated by the prefiltration unit first and then flowed to EC-I and EC-II. Then salt was further removed by EC-III. The product water was collected after activated carbon filter. A 300V power was applied to all of the electrochemical cell.

A flow sensor was positioned at V2 and the device is programmed to change polarity after 12 L of water is passed through V2 After 12 L water was collected, solenoid valves V1 and V2 were closed. The three electrochemical cells were removed from the deionization process and directly connected to the feed water inlet for regeneration. During the regeneration, the polarity of the power supply was opposite with that in deionization stage. 300V power was applied, water was flowed to the cartridge at 190 ml/min for 40 min. During this period, EC-I, EC-II and EC-III are regenerated one by one. For EC-I regeneration, FLV, FLV1 and WLV1 are open and rest of the valves are closed. For EC-II regeneration, valves FLV, FLV2 and WLV2 are open and rest of the valves are closed. For EC-III regeneration, FLV, FLV3 and WLV3 are open and rest of the valves are closed. The observations are tabulated in table 1.

TABLE 1

| | Salt Removal Performance (TDS) | | | |
|---|---|---|---|---|
| System | Flow rate | Product water | | Salt removal rate |
| Unit I (EC-I, EC-II | 2 L/min | 10 | mg/L | 98% |
| in parallel) + Unit-II | | | | |
| (EC-III in series) | | | | |
| EC-I, EC-II, EC-III | 2 L/min | 35 | mg/L | 91% |
| in parallel | | | | |
| EC-I, EC-II, EC-III | 2 L/min | 10 | mg/L | 98% |
| in series | | | | |
| EC-I | 1 L/min | 37 | mg/L | 91% |
| | 2 L/min | 118 | mg/L | 71% |

The reaction was performed at the flow rate of 2 L/min and the test result was compared with the reaction result using 1 ERIX cartridge.

For a system using only EC-I, the salt removal rate was 91% at 1 L/min and 71% at 2 L/min. However, in the device of the present invention, the salt removal rate of the whole system was 98% at 2 L/min. The salt removal rate was increased with higher flow rate.

Though the device of the present invention and the device having EC-I, EC-II, EC-III in series appear to be having the same performance based on the parameters as disclosed in Table 1, however the device of the present invention was found to be even superior to the device with EC-I, EC-II, EC-III in series as the pressure drop of the latter system was much higher (almost two times) than the pressure drop seen in the present device.

1. A water treatment device (1) comprising:
a) a first inlet (2A) feeding water into line L₀;
b) a prefiltration unit (10);
c) an electrochemical cell assembly (20) capable of removing ions from a solution stream, the assembly comprising of a Unit-I, comprising at least two electrochemical cells (EC-I, EC-II) connected in parallel with each other, and a Unit-II, comprising of least one electrochemical cell connected in series to the Unit-1, each cell (20) comprising:
(i) a housing (25) having first (40) and second (45) electrodes;
(ii) at least one water-splitting ion exchange membrane (100) positioned between the electrodes (40, 45), the water-splitting membrane (100) comprising (i) a cation exchange surface (105) facing the first electrode (40), and (ii) an anion exchange surface (110) facing the second electrode (45); and
(iii) a solution stream pathway defined by the water-splitting membrane (100), the solution stream pathway (121) having (i) an inlet for influent solution stream, (ii) at least one channel that allows influent solution stream to flow past at least one surface of the water-splitting membrane (100) to form one or more treated solution streams, and (iii) a single outlet that combines the treated solution streams to form a single effluent solution;
wherein the line L₀ branches into lines L₁ and L₂ at point M to allow passage of water through Unit-1, L₁ leading to EC-I and L₂ leading to EC-II respectively, the lines L₁ and L₂ merge back into line L₀ at point N; and
wherein Unit-II is positioned downstream of point N; wherein Unit-1 and Unit-2 can be positioned interchangeably; wherein each cell is capable of operating in two stages, deionization stage and regeneration state;
d) a second inlet (2B) for feeding water into line FL during regeneration state of the electrochemical cells, wherein FL feeds water into Unit-I and Unit-II through lines FL12 and FL3 respectively; wherein line FL12 further branches into lines FL1 and FL2 to feed water into EC-I and EC-II respectively;
e) a wastewater line (WL) for discarding wastewater from the two units Unit-I and, Unit-II;
f) a carbon filtration unit (17) positioned downstream of the electrochemical cell assembly (20);
g) an outlet (5A) for dispensing treated water; and
h) an outlet (5B) for discarding wastewater during regeneration stage of one or more of electrochemical cells.

2. The device (1) according to claim 1, wherein the solution stream pathway (121) comprises a unitary and contiguous solution channel that flows past both the cation and anion exchange surfaces (105, 110) of the water-splitting membrane (100).

3. The device (1) according to claim 1 wherein the cell (20) comprises a plurality of water-splitting membranes (100), and wherein the solution stream pathway (121) comprises a unitary and contiguous solution channel (122) that flows past (i) the electrodes (40,45), and (ii) both the cation and anion exchange surfaces (105, 110) of each water-splitting membrane (100).

4. The device (1) according to claim 1 the cell (20) comprising a plurality of interdigited water-splitting membranes (100) having alternating ends attached to the housing (25).

5. The device (1) according to claim 1, wherein (i) the water-splitting membranes (100) are rolled in a spiral arrangement to form a cylindrical shape, and (ii) the first or second electrode (40,45) comprises a cylinder enclosing the spiral arrangement of water-splitting membranes (100).

6. The device (1) according to claim 5, wherein the solution stream pathway (121) allows the influent solution stream to flow past both the cation and anion exchange layer surfaces (105, 110) of the water-splitting membranes (100) in the direction of the spiral.

7. The device (1) according to claim 1 wherein the water-splitting membrane (100) comprises at least one of the following characteristics:
a) a cation exchange surface (105) comprising a chemical group selected from the group consisting of —SO₃M, —COOM, —PO₃M₂, —C₆H₄OM, aliphatic amines, aromatic amines, aliphatic phosphines, aromatic phosphines, aliphatic sulfides, aromatic sulfides, aminophosphoric acid, aminocarboxylic acid, hydroxamic acid, and mixtures thereof, where M is a cation;
b) an anion exchange surface (110) comprising a chemical group selected from the group consisting of aliphatic amines, aromatic amines, aliphatic phosphines, aromatic phosphines, aliphatic sulfides, aromatic sulfides, and mixtures thereof; or
c) the membranes are heterogeneous and comprise cross-linked water-swellable polymeric host material.

8. The device (1) according to claim 1 wherein the cation exchange surfaces (105) of the water-splitting membranes (100) comprise at least two cation exchange layers each comprising different cationic chemical groups.

9. The device (1) according to claim 8, wherein an inner cation exchange layer comprises SO₃⁻ chemical groups, and an outer cation exchange layer comprises an ion exchange chemical group other than SO₃⁻.

10. The device (1) according to claim 1 wherein the anion exchange surfaces (110) of the water-splitting membranes (100) comprise at least two anion exchange layers each comprising different cationic chemical groups.

11. The device (1) according to claim 10, wherein an inner anion exchange layer comprises NR₃⁺ groups, and an outer anion exchange layer comprises ion exchange groups other than NR₃⁺, where R is selected from the group consisting of aliphatic hydrocarbons, aliphatic alcohols, and aromatic hydrocarbons.

12. A method of treating water using the device according to claim 1, the method comprising steps of:
(i) allowing the water to filter through the prefiltration unit (10);
(ii) replacing ions in an ion exchange material of an electrochemical cell assembly (20), of a Unit-I, comprising at least two electrochemical cells (EC-I, EC-II) connected in parallel with each other, and a Unit-II, comprising of least one electrochemical cell connected in series to the Unit-1, each cell (20) comprising:
a) first and second electrodes (40, 45);
b) at least one water-splitting membrane between the electrodes, each at least one water-splitting membrane (100) between the electrodes (40, 45), each water-splitting membrane (100) comprising ion exchange layers A and B, one a cation exchange layer facing the first electrode (40) and the other an anion exchange layer facing the second electrode (45), which layers contain ions 11A and 11B respectively;
wherein a unitary and contiguous solution channel is defined by the cation and anion exchange layer surfaces (105, 110) of the membranes, the solution channel (122) abutting both electrodes (40, 45) and extending continuously from the inlet (30) to the outlet (35) of the housing (25);
c) an ion-containing solution electrically connecting the electrodes (40, 45) and the water-splitting membranes (100); and in which cell ions I_{1A} and I_{1B} are replaced by ions I_{2A} and I_{2B}, respectively;
wherein the water-splitting membranes (100) are arranged to provide a continuous channel (122) that allows a stream of solution to flow past both the cation and anion exchange layer surfaces (105, 110) of the water-splitting membranes (100),
wherein the solution in at least one channel (122) of the cell (20) is simultaneously exposed to a cation and an anion exchange layer surface (105, 110) of water-splitting membranes (100); and
(iii) allowing the water from the electrochemical cell assembly (20) to be filtered by the carbon filtration unit (17); and
(iv) dispensing from the outlet (5A) during the deionization state;
wherein at a given point in time, at least one electrochemical cell is in the state of regeneration state;
wherein the cell which is in state of repolarization allows water to flow from feed water line FL into one of respective feed water line FL1, FL2 or FL3 in opposite direction with respect to flow of water during the deionization state; and water exiting from the electrochemical cell which is in the state of repolarization is discarded through wastewater line WL through one of the respective wastewater lines WL1, WL2 or WL3.

13. The method according to claim 12, wherein when the EC-I is in regeneration stage, water enters into EC-I from feed line FL through line FL1 after passing through EC-I, the water enters into line WL1 and is discarded into the wastewater outlet 5B through wastewater line WL.

14. The method according to claim 12, wherein when the EC-II is in regeneration stage, water enters into EC-II from feed line FL through line FL2 after passing through EC-I, the water enters into line WL2 and is discarded into the wastewater outlet 5B through wastewater line WL.

15. The method according to claim 12, wherein when the EC-III is in regeneration stage, water enters into EC-III from feed line FL through line FL3 after passing through EC-I, the water enters into line WL3 and is discarded into the wastewater outlet 5B through waste water line WL.
